(19) United States
(12) Patent Application Publication
(10) Pub. No.: US 2023/0188643 A1
(43) Pub. Date: Jun. 15, 2023

(54) AI-BASED REAL-TIME NATURAL LANGUAGE PROCESSING SYSTEM AND METHOD THEREOF

(71) Applicant: Prodigal Technologies Inc., Mountain View, CA (US)

(72) Inventors: Nayrhit Bhattacharya, Chicago, IL (US); Shantanu Gangal, Mountain View, CA (US)

(21) Appl. No.: 17/549,928

(22) Filed: Dec. 14, 2021

(51) Int. Cl. H04M 3/42; G06F 40/20; G06N 20/00

(52) U.S. Cl. CPC H04M 3/42221; G06F 40/20; G06N 20/00

(57) ABSTRACT

A method and a system are disclosed for generating in real-time, automated summary notes with respect to an ongoing conversation call between a customer and a call center agent. A plurality of events is predefined based on context of a plurality of historical conversation calls. The audio feeds of the ongoing conversation call are received and transcribed into text. A plurality of key events may be identified based on speech signals and one or more keywords from the transcribed audio feeds. Thereafter, context of each of the plurality of key events is analyzed to shortlist a subset of key events. The shortlisted subset of key events is published in human-readable language to thereby generate the call summary note.

### FIELD OF THE DISCLOSURE

The present invention relates to natural language processing and more particularly to Artificial Intelligence (AI) based real-time natural language processing for generating automated call summary notes.

### BACKGROUND OF THE DISCLOSURE

Various business organizations are often associated with dedicated call centers to interact with their customers. In financial service sector, many call centers specialize in debt collections and customer service, wherein agents or executives of the call centers speak to the customers. The agents or executives of the call centers spend a lot of time in making the calls to speak with their customers. The minutes of conversations between agents and consumers are also required to be noted down for further analysis by respective organizations. Conventionally, the agents are required to manually summarize the call notes during or after the conversation is completed. The process of manually summarizing the call notes for each call is tedious and takes a lot of time. A typical agent spends around 25% of their working hours in taking notes of the call which reduces their efficiency to a large extent. Further, the process of manually taking notes of the call summary is prone to human errors.

Furthermore, the call conversation between the agents and the customers are dynamic in nature. The conventional method of typing in manual notes after each call by the agents and prepare call summary, is therefore not structured and standardized. While some notes written by some agents may provide precise information, some other notes may not include critical information due to human errors.

In view of the above, the present subject matter as disclosed herein, aims to provide AI-based real-time natural language processing with respect to a call conversation, for subsequently generating effective call summary notes. In addition, a novel platform is required to automatically generate structured and standardized call notes after each call.

### SUMMARY

In order to provide a holistic solution to the above-mentioned limitations, it is necessary to provide a platform for natural language processing for generating automated call summary notes.

An object of the present disclosure is to provide AI-based real-time natural language processing for generating automated call summary notes.

Another object of the present disclosure is to automatically make structured and standardized call notes for each call.

According to an embodiment of the present disclosure, there is provided a system for automatically generating, in real-time, a call summary note with respect to an ongoing conversation call between a customer and a call center agent. The system comprises: at least one receiving module to receive audio feeds of the ongoing conversation call; a call summary generating module configured to: store a plurality of predefined events based on context of a plurality of historical conversation calls; transcribe the received audio feeds into texts in real-time; identify a plurality of key events based on speech signals and one or more keywords from the transcribed audio feeds; analyze context of each of the plurality of key events to shortlist a subset of key events; and articulate the shortlisted subset of key events in human-readable language to thereby generate the call summary note.

According to an embodiment of the present disclosure, the at least one audio feeds receiving module is integrated with at least one call center telephony system to listen-in to conversation calls in real-time for thereby receiving the audio feeds.

According to an embodiment of the present disclosure, the at least one audio feeds receiving module receives and records the audio feeds in machine readable format.

According to an embodiment of the present disclosure, the one or more key events are identified from the plurality of predefined events.

According to an embodiment of the present disclosure, the shortlisted subset of key events is articulated in human-readable language using Natural Language generation mechanism.

According to an embodiment of the present disclosure, the generated call summary note is in a standardized format.

According to an embodiment of the present disclosure, the generated call summary note is published via a user interface and displayed to the call center agent.

According to an embodiment of the present disclosure, the generated call summary note is edited by the call center agent.

According to an embodiment of the present disclosure, the call summary generating module comprises an AI module executing machine learning algorithms.

According to an embodiment of the present disclosure, the AI module uses the generated call summary note as feedback to the machine learning algorithms.

According to an embodiment of the present disclosure, a method is disclosed for automatically generating, in real-time, a call summary note with respect to an ongoing conversation call between a customer and a call center agent. The method comprises: configuring at least one audio feeds receiving module to receive audio feeds of the ongoing conversation call; configuring a call summary generating module for: storing a plurality of predefined events based on context of a plurality of historical conversation calls; transcribing the received audio feeds into texts in real-time; identifying a plurality of key events based on speech signals and one or more keywords from the transcribed audio feeds; analyzing context of each of the plurality of key events to shortlist a subset of key events; and articulating the shortlisted subset of key events in human-readable language to thereby generate the call summary note.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present invention, and is therefore, not intended to define key features or scope of the subject matter of the present invention.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present invention will be apparent from the following description when read with reference to the accompanying drawings:

FIG. 1 illustrates a system architecture, according to an exemplary embodiment of the invention disclosure;

FIG. 2 illustrates the elements of the call notes generating module, according to an exemplary embodiment of the present invention disclosure;

FIG. 3a and FIG. 3b are screenshots that illustrate the generation of a call summary note for any agent, according to an exemplary embodiment of the present invention disclosure; and

FIG. 4 illustrates the method for automatically generating, in real-time, a call summary note with respect to an ongoing conversation call between a customer and a call center agent, according to an exemplary embodiment of the present invention disclosure.

Like reference numerals refer to like parts throughout the description of several views of the drawings.

### DETAILED DESCRIPTION OF THE INVENTION

This section is intended to provide explanation and description of various possible embodiments of the present invention. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

The present invention discloses automated creation of voice call summary notes in a human readable language. The call summary note is generated in real-time with respect to an ongoing conversation call between a customer and a call center agent. The audio feeds of the ongoing conversation call may be received and transcribed into text in real-time. A plurality of events is predefined based on context of a plurality of historical conversation calls. A plurality of key events may be identified based on speech signals and one or more keywords from the transcribed audio feeds. Thereafter, context of each of the plurality of key events is analyzed to shortlist a subset of key events. The shortlisted subset of key events is published in human-readable language to thereby generate the call summary note.

As used herein, ‘AI-module’ is an artificial intelligence enabled device or module, that is capable of processing digital logics and also possesses analytical skills for analyzing and processing various data or information, according to the embodiments of the present invention.

As used herein, ‘database’ refers to a local or remote memory device; docket systems; storage units; each capable to store information including, voice data, speech to text transcriptions, customer profiles and related information, audio feeds, metadata, predefined events, call notes, etc. In an embodiment, the storage unit may be a database server, a cloud storage, a remote database, a local database.

As used herein, ‘user device’ is a smart electronic device capable of communicating with various other electronic devices and applications via one or more communication networks. The user device comprises: an input unit to receive one or more input data; an operating system to enable the user device to operate; a processor to process various data and information; a memory unit to store initial data, intermediary data and final data; and an output unit having a graphical user interface (GUI).

As used herein, ‘module’ or ‘unit’ refers to a device, a system, a hardware, a computer application configured to execute specific functions or instructions according to the embodiments of the present invention. The module or unit may include a single device or multiple devices configured to perform specific functions according to the present invention disclosed herein.

Terms such as ‘connect’, ‘integrate’, ‘configure’, and other similar terms include a physical connection, a wireless connection, a logical connection or a combination of such connections including electrical, optical, RF, infrared, Bluetooth, or other transmission media, and include configuration of software applications to execute computer program instructions, as specific to the presently disclosed embodiments, or as may be obvious to a person skilled in the art.

Terms such as ‘send’, ‘transfer’, ‘transmit’ and ‘receive’, ‘collect’, ‘obtain’, ‘access’ and other similar terms refers to transmission of data between various modules and units via wired or wireless connections across a network. The ‘network’ includes a local area network (LAN), a wide area network (WAN), a metropolitan area network (MAN), a virtual private network (VPN), an enterprise private network (EPN), Internet, cloud-based network, and a global area network (GAN).

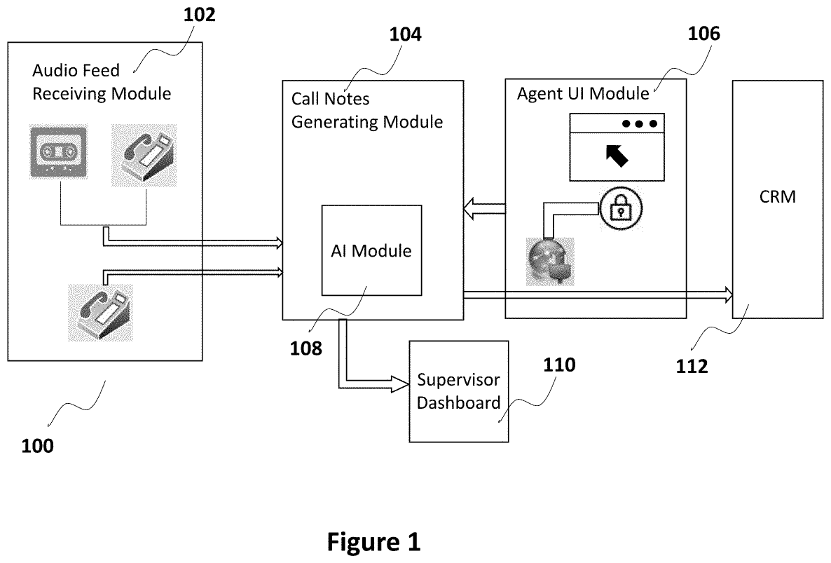

FIG. 1 illustrates architecture of a system 100 for automatically generating, in real-time, a call summary note with respect to an ongoing conversation call between a customer and a call center agent using one or more user devices, according to an exemplary embodiment of the present invention. The system 100 comprises at least one audio feeds receiving module 102 (or ‘receiving module’), a call summary generating module 104 (or ‘call notes generating module’), an agent UI module 106, a supervisor interfacing module or dashboard 110 and a CRM 112 (Customer Relationship Management) interfacing module. The call summary generating module 104 comprises an AI module 108.

The call summary generating module 104 is an AI enabled module and may be implemented in a cloud-based environment to be accessed, via corresponding user devices, by one or more agents or executives of a call center while making a plurality of calls to their customers or consumers. The system facilitates in automated generation of call notes for the call center agents in a structured and standardized manner. The call notes are generated automatically and are displayed in an editable text box or window to the call center agents on their device screens via the agent user interface module. The automatically generated call notes are the condensed call notes that present the contextual and effective summary of the call. In an event the agents wish to edit the notes before submitting the same to the CRM interfacing module 112, they can make the edits or changes as per their requirements. The system as disclosed herein, facilitates in eliminating manual process of writing down the notes with respect to various phone calls attended by the agents. This in turn helps the agents in saving their time and also cut down the errors that is likely to occur due to careless human mistakes while manually noting down the minutes of the calls.

According to the embodiments of the present subject matter, for each conversation call, once the call ends, the summary note is generated within few seconds of time. The generated call note is subsequently displayed to the respective agent in an editable text box. The respective agent is facilitated to use and submit the notes as is, or review the notes to modify according to their requirements. The call notes may be edited or modified by adding required words or phrases as per the events that occurred in the particular call. The final summary notes may be then submitted by the agents to respective CRMs for further analysis and processing. The notes may be posted instantaneously to API endpoint. The notes may also be sent via webhook in real time or may be ship to SFTP (secure file transfer protocol) in periodic flat files.

According to an embodiment of the present disclosure, the at least one audio feeds receiving module 102 is integrated with at least one call center telephony system to listen-in to conversation calls in real-time for thereby receiving the audio feeds. The at least one receiving module 102 is configured to receive audio feeds of the ongoing conversation call. Said receiving module 102 may provide interfacing with one or more dialers, client audio recorder, SIPREC (Session Recording Protocol) units and devices etc., for recording the live calls. The call summary generating module 104 may be configured to receive the audio feeds in a machine-readable format. The call summary generating module 104 may include an AI module 108 with machine learning capabilities. The AI module 108 may be communicatively connected to one or more servers and databases that facilitates in storing a plurality of predefined events based on context of a plurality of historical conversation calls. The historical calls may include the recordings of the conversation calls or the voice calls that occurred in the past. The historical call data may be analysed along with a set of other possible objectives to create or predefine a plurality of events.

Further, the received audio feeds are transcribed into texts in real-time while the conversation is ongoing between the agents and their customers. A plurality of key events may be identified based on speech signals and one or more keywords from the transcribed audio feeds. The plurality of key events is identified from the plurality of predefined events that are pre-stored. The AI module 108 analyzes context of each of the plurality of key events to shortlist a small subset of key events and thereafter, articulate the shortlisted subset of key events in human-readable language to thereby generate the call summary note for the agent on the call. The system as disclosed herein thus provides a structured, standardized and more readable notes with increased transparency and efficient documentation within any organization.

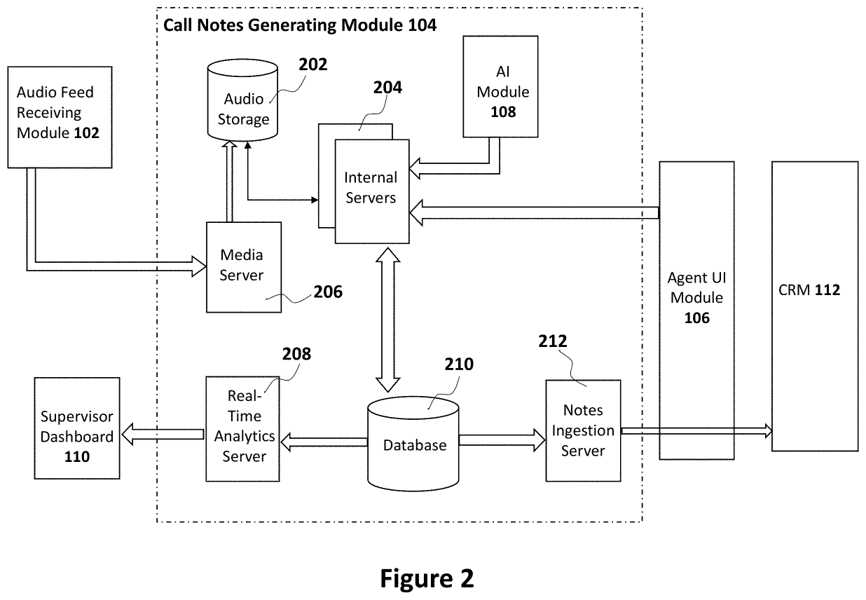

FIG. 2 illustrates the elements of the call notes generating module 104, according to an exemplary embodiment of the present invention disclosure. The call notes generating module 104 comprises an audio storage 202, one or more internal servers 204, a media server 206, a real time analytics server 208, a database 210, and a notes ingestion server 212. The call summary generating module 104 also comprises the AI module 108 capable of executing machine learning algorithms.

The audio feed receiving module 102 is communicatively coupled to telephony systems. The call centers use various telephony systems to call their customers through their agents or executives. The audio feed receiving module 102 may be integrated with the telephony systems using API connectors to plug in to a call conversation in real time. Preferably, a bot may be configured to listen to the calls and record the audio calls. Further, multiple concurrent conversations may be listened and recorded in real time. The recorded audio feeds for each call are received by the media server 206 and sent to the audio storage 202 that is configured to store the recorded audio. The media server 206 standardizes the received audio before feeding it to the audio server. In other words, the audio feeds are converted into machine interpretable format that is understood and processed by the neural network models of the AI module 108. The AI module 108 receives the readable audio feeds and performs speech to text transcription. In preferred embodiments of the present subject matter, ‘Vanilla’ speed to text conversion algorithms may be used by the AI module 108 for performing the transcriptions. Since the transcription so obtain may contain too many words according to the length of the conversation call, hence it is very much required to cut short the long transcription into a short one that has only substantial description of events. The long transcription is accordingly summarized into a precise transcription. The AI module 108 summarizes the long form of the transcribed texts by identifying the critical and substantial part of the conversation call. The critical portions of the conversations are analysed by understanding the context of the conversation between the agent and the customer on the call. The AI module 108s publishes the critical portions that should appear in the summary of a conversation call. Further, the AI module 108 also interplays with the information of multiple conversations. For example, AI module 108 is capable of deciding which of the information should be published in the call summary note. In the event when two or more calls are of similar nature, wherein ‘information A’ is important in ‘Call 1’, whereas ‘information B’ is important in ‘Call 2’, then AI interplays with overall information to decide what information should be published in the note to be generated for both calls.

Further, as explained above, the plurality of predefined events is based on context of a plurality of historical conversation. The events identified in the previous or historical calls may be stored in the database 210. The plurality of predefined events may include, but is not limited to ‘payment authorization’, ‘payment reminder’, ‘preferred online payment’, ‘wrong number’ etc. The historical conversations include the recordings of the previously occurred voice calls that may be analysed along with a set of other possible objectives to create or predefine the plurality of events. In order to identify the important set of events happened during a conversation, the AI module 108 refers to the plurality of predefined events stored in the database 210. The AI module 108 thus has access to the list of predefined events from the database 210 and internal servers 204. The AI module 108 comprises neural network models that interpret the call to understand at their end, what are the situations or events that are happening in the ongoing call in real-time. All events occurring in the call are analysed to select the critical events. A plurality of key events may be identified based on speech signals and one or more keywords from the transcribed audio feeds. For example, in a call pertaining to enquire about a debt settlement from a consumer, the critical events or situations may include ‘verification of the consumer using personal details such as date of birth’, ‘amount of debt to be paid by the customer in how many days’, ‘discount asked by the customer’, etc. The above-mentioned events may be analysed by the AI module 108 based on the keywords of the transcriptions as well as the mapping of the call events to the predefined plurality of events stored in the database 210. According to the embodiments of the present invention disclosure, the AI module 108 performs mapping of the conversation into very objective binary bits. wherein the identified one or more key events are verified by the call-center agent. This helps in shortlisting the list of key events from a long list as initially transcribed by the AI module 108. The shortlisted subset of key events may be thereafter articulated in human-readable language using Natural Language generation mechanism to generate the call note. The generated call summary note is in a standardized format. The generated call summary note is published via a user interface and displayed to the call center agent.

Further, the AI module 108 has the machine learning capabilities. Every time an agent edits the note, it is sent back as feedback to the AI module 108. The AI module 108 thus uses the generated call summary note as its feedback to the machine learning algorithms. Over the time, with use of the machine learning algorithms, the AI module 108 self learns and adapts the agent's style of editing the summary notes. The agent UI module 106 provides an interface to the agents to interact with the AI module 108. The internal servers 204 are configured to interact with the agent UI model using web socket connection. In order to provide the feedback to the AI module 108, the agent UI module 106 ingests the call notes back to the internal servers 204. The notes ingestion server 212 and the internal servers 204 are configured to provide the stored audio records and also the feedback from the UI agent module to the AI module 108.

In the embodiments of the present subject matter, the AI module 108 is further configured to assign important events amongst each other, based on the context of the conversation, and based on how the call is progressed. Based on the context, the AI module 108 may analyse and identify important events amongst all the events taking place during the call. The AI module 108 uses AI/ML models to predict the most accurate events or the key events, for call note generation purposes.

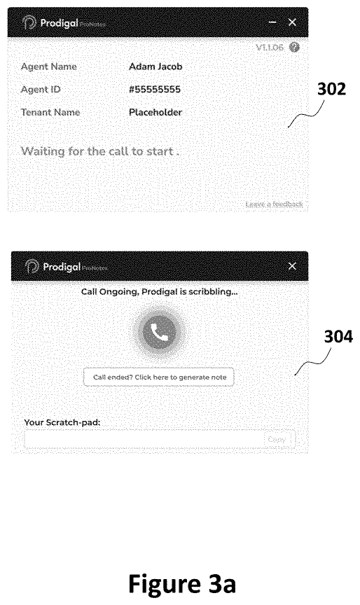

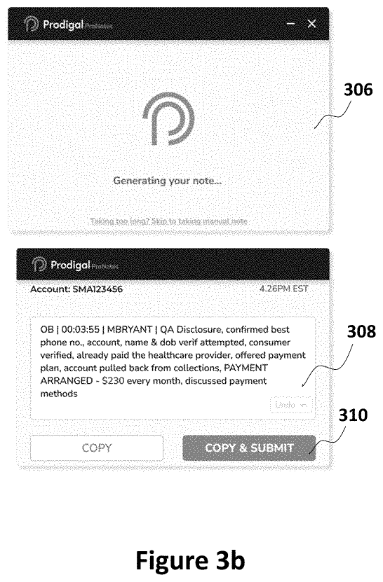

FIG. 3a and FIG. 3b are screenshots that illustrate the generation of a call summary note for any agent, according to an exemplary embodiment of the present invention disclosure.

FIG. 3a shows screenshots of an exemplary scenario when a call is being placed by an agent to a customer. The agent id number and name of the customer is displayed 302 before the call is started. While the call is ongoing, the scribbling of the note is taking place at the back end. The agent is also indicated to generate the summary note after the call ends 304.

FIG. 3b likewise, shows exemplary screenshots of note being generated 306 after the call is ended. The generated note is published with the set of key events and is displayed to the agent on the screen 308. The agent may thereafter edit the note and send it to the CRM 112 as explained earlier. The agent may also make a copy of the generated note 310.

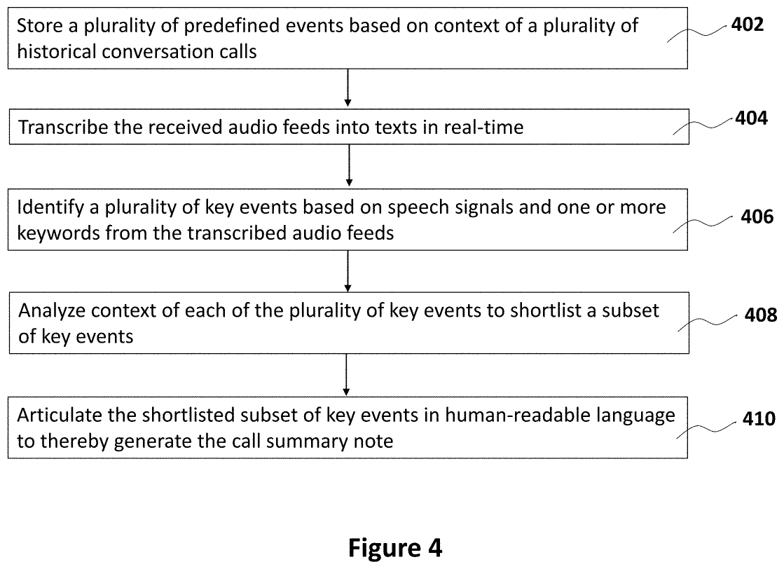

FIG. 4 illustrates the method for automatically generating, in real-time, a call summary note with respect to an ongoing conversation call between a customer and a call center agent, according to an exemplary embodiment of the present invention disclosure.

At step 402, a plurality of predefined events is stored based on context of a plurality of historical conversation calls. The at least one receiving module 102 to receive audio feeds of the ongoing conversation call. The call summary generating module 104 is configured to store a plurality of predefined events based on context of a plurality of historical conversation calls. The at least one audio feeds receiving module 102 is integrated with at least one call center telephony system to listen-in to conversation calls in real-time for thereby receiving the audio feeds. The at least one audio feeds receiving module 102 receives and records the audio feeds in machine readable format. The plurality of predefined events may be stored in the database 210. The plurality of predefined events may include, but is not limited to ‘payment authorization’, ‘payment reminder’, ‘preferred online payment’, ‘wrong number’ etc. The above-mentioned events or situations are predefined based on the occurrences of similar events during previously held calls. The historical call conversations may include the recordings of the previously occurred voice calls that is analysed over a period of time along with a set of other possible objectives to create or predefine the plurality of events. The predefined plurality of events may increase with more number of calls and more types of events occurrences.

At step 404, the received audio feeds are transcribed into texts in real-time. The transcription is performed by the AI module 108 which is having the machine learning capabilities. The call summary generating module 104 is configured that comprises one or more databases 210 for storing the plurality of predefined events based on context of a plurality of historical conversation calls. Transcribe the audio feeds into text in real-time and assign speaker to each word based on the voices and channels of the audio.

At step 406, a plurality of key events is identified based on speech signals and one or more keywords from the transcribed audio feeds. The transcribed audio feeds contain one or more keywords, based on which the AI algorithm performs identification of key situations and occurrences from the conversations.

At step 408, the context of each of the plurality of key events is analyzed to shortlist a subset of key events. The one or more key events are identified from the plurality of predefined events. The summarization algorithm being executed by the AI module 108, analyzes the complete call transcript to further shortlist and contextualize the identified keywords. In this process, critical or key situations are selected to create into a smaller list of events by the AI module 108.

At step 410, the shortlisted subset of key events is articulated in human-readable language to thereby generate and publish the call summary note. In order to publish the key events in a human readable language, the AI uses the Natural Language generation. The AI predicted notes are error free and provides better readability. The notes generated by the AI module 108 for various different calls are same in structure.

The embodiments of the present invention disclosure thus provide a real-time Artificial Intelligence (AI) and Natural Language Processing (NLP) based solution that listens, transcribes and summarizes to live ongoing conversations between agents and consumers in call centers which specialize in debt collections and customers servicing for financial institutions extracts key elements. The AI module 108 is engineered to generate standardized note having few precise words that represents the summary of the call that transpires in real-time. With conventional method of manually writing down the call summary notes, a typical agent needed to spend a quarter of their shift. reduces this note-taking time drastically. In addition, it also introduces structured, standardized and more readable notes thus increasing the transparency and documentation within any organization

The embodiments of the present subject matter facilitate in providing a platform to generate automated, condensed and effective notes during an ongoing call in real-time. Many organisations such as call centers associated with financial institutions and debt collection sectors may be benefited by implementing the system and method as described above. The agent's productivity may be increased as the automated note generation saves several hours of agent's time every day. Further, the notes are more standardized and accurate because the machine-generated notes are free from human errors and human subjectivity. Furthermore, the notes are with better readability as the notes follow the same structure and pattern and do not contain unnecessary information, which makes the notes easy to read.

It will be understood by those skilled in the art that the figures are only a representation of the structural components and process steps that are deployed to provide an environment for the solution of the present invention disclosure discussed above, and does not constitute any limitation. The specific components and method steps may include various other combinations and arrangements than those shown in the figures.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

What claimed is:

1. A system for automatically generating, in real-time, a call summary note with respect to an ongoing conversation call between a customer and a call center agent, the system comprising:
at least one receiving module to receive audio feeds of the ongoing conversation call;
a call summary generating module configured to:
store a plurality of predefined events based on context of a plurality of historical conversation calls;
transcribe the received audio feeds into texts in real-time;
identify a plurality of key events based on speech signals and one or more keywords from the transcribed audio feeds;
analyze context of each of the plurality of key events to shortlist a subset of key events; and
articulate the shortlisted subset of key events in human-readable language to thereby generate the call summary note.

2. The system of claim 1, wherein the at least one receiving module is integrated with at least one call center telephony system to listen-in to conversation calls in real-time for thereby receiving the audio feeds.

3. The system of claim 1, wherein the at least one receiving module receives and records the audio feeds in machine readable format.

4. The system of claim 1, wherein the one or more key events are identified from the plurality of predefined events.

5. The system of claim 1, wherein the shortlisted subset of key events is articulated in human-readable language using Natural Language generation mechanism.

6. The system of claim 1, wherein the generated call summary note is in a standardized format.

7. The system of claim 1, wherein the generated call summary note is published via a user interface and displayed to the call center agent.

8. The system of claim 1, wherein the generated call summary note is edited by the call center agent.

9. The system of claim 1, wherein the call summary generating module comprises an AI module executing machine learning algorithms.

10. The system of claim 9, wherein the AI module uses the generated call summary note as feedback to the machine learning algorithms.

11. A method for automatically generating, in real-time, a call summary note with respect to an ongoing conversation call between a customer and a call center agent, the method comprising:
configuring at least one receiving module to receive audio feeds of the ongoing conversation call;
configuring a call summary generating module for:
storing a plurality of predefined events based on context of a plurality of historical conversation calls;
transcribing the received audio feeds into texts in real-time;
identifying a plurality of key events based on speech signals and one or more keywords from the transcribed audio feeds;
analyzing context of each of the plurality of key events to shortlist a subset of key events; and
articulating the shortlisted subset of key events in human-readable language to thereby generate the call summary note.

12. The method of claim 11, wherein the at least one receiving module is integrated with at least one call center telephony system to listen-in to conversation calls in real-time for thereby receiving the audio feeds.

13. The method of claim 11, wherein the at least one receiving module receives and records the audio feeds in machine readable format.

14. The method of claim 11, wherein the one or more key events are identified from the plurality of predefined events.

15. The method of claim 11, wherein the shortlisted subset of key events is articulated in human-readable language using Natural Language generation mechanism.

16. The method of claim 11, wherein the generated call summary note is in a standardized format.

17. The method of claim 11, wherein the generated call summary note is published via a user interface and displayed to the call center agent.

18. The method of claim 11, wherein the generated call summary note is edited by the call center agent.

19. The method of claim 11, wherein the call summary generating module comprises an AI module executing machine learning algorithms.

20. The method of claim 19, wherein the AI module uses the generated call summary note as feedback to the machine learning algorithms.
